(19) United States
(12) Patent Application Publication
(10) Pub. No.: US 2025/0353210 A1
(43) Pub. Date: Nov. 20, 2025

(54) METHOD OF MANUFACTURING AN IMPROVED ORIENTED STRAND BOARD PANEL

(71) Applicant: LOUISIANA-PACIFIC CORPORATION, NASHVILLE, TN (US)

(72) Inventors: KEITH QUISENBERRY, PEGRAM, TN (US); QINING SUNG, FRANKLIN, TN (US); JIANWEN NI, FRANKLIN, TN (US); CHRISTINA M. YOUNGERS, NASHVILLE, TN (US); MINA EKSANDER, NOLENSVILLE, TN (US)

(21) Appl. No.: 19/212,333

(22) Filed: May 19, 2025

Related U.S. Application Data
(60) Provisional application No. 63/649,423, filed on May 19, 2024.

(51) Int. Cl. B27N 3/02; B27N 3/00; B32B 21/02

(52) U.S. Cl. CPC B27N 3/02; B27N 3/002; B32B 21/02; B32B 2250/03

(57) ABSTRACT

An improved oriented strand board (OSB) panel or board with higher resin loading and control of the density to provide improved and/or enhanced properties, and methods of manufacturing such an improved OSB panel or board. In several exemplary embodiments, as described in greater detail below, resin loading of the strands used for OSB formation is increased in conjunction with the density of the manufactured OSB board being controlled to a certain density or within certain density ranges for use with decorative panels, exterior cladding or siding panels, engineered wood flooring, and/or exterior structural wall or roofing panels. Both increased resin-loading and controlled density increases are required for overall core performance increases, and the surprisingly enhanced performance characteristics outweigh the increased cost of production.

This application claims priority to and benefit of U.S. Provisional App. No. 63/649,423, filed May 19, 2024, which is incorporated herein by specific reference for all purposes.

### FIELD OF INVENTION

This invention relates to a product and process of manufacturing an improved wood composite panel, such as oriented strand board (OSB), or other cellulose-based panels, with enhanced resin loading and density to provide increased dimensional stability and other benefits.

### BACKGROUND OF THE INVENTION

In general, wood-based composites include, but are not limited to, oriented strand board (OSB), wafer board, flake board, particleboard, and fiberboard (e.g., medium density fiberboard, or MDF). These wood-based composites (also referred to as manufactured wood or engineered wood) are typically formed from a wood element (e.g., flake, strand, particle, wafer) combined with a thermosetting adhesive to bind the wood substrate together. In some processes, other additives are added to impart additional properties to the wood composites. Additives may include fire retardants, fungicides, mildewcides, insecticides, and water repellents. A significant advantage of strand and particle-based wood composites is that they have many of the properties of plywood and dimensional lumber, but can be made from a variety of lower grade wood species, smaller trees and waste from other wood product processing. In addition, they can be formed into panels in lengths and widths independent of the size of the harvested timber.

One class of wood-based composites products comprise multilayer, oriented wood strand panel products. These oriented-strand, multilayer composite wood panel products are composed of several layers of thin wood strands, which are wood particles having a length which is several times greater than their width. These strands are created from debarked round logs by placing the edge of a cutting knife parallel to a length of the log and then slicing thin strands from the log. The result is a strand in which the fiber elements are substantially parallel to the strand length. These strands can then be oriented on a mat-forming line with the strands of the outer face layers predominantly oriented in a parallel-to-machine direction, and strands in the core layer generally oriented perpendicular to the face layers (i.e., “cross-machine”) direction.

In one known commercial process, these mat layers are bonded together using natural or synthetic adhesive resins under heat and pressure to make the finished product. Oriented, multilayer wood strand panels of the above-described type can be produced with mechanical and physical properties comparable to those of commercial softwood plywood and are used interchangeably, such as for wall and roof sheathing. In certain types of construction, these wood-based panels (and other construction materials) may be required by building codes to meet certain durability requirements, such as fire, wind and water resistance.

Oriented, multilayer wood strand panels and similar products of the above-described type, and examples of processes for pressing and production thereof, are described in detail in U.S. Pat. Nos. 3,164,511, 4,364,984, 5,425,976, 5,470,631, 5,525,394, 5,718,786, and 6,461,743, all of which are incorporated herein in their entireties by specific reference for all purposes.

### SUMMARY OF INVENTION

In various exemplary embodiments, the present invention comprises an improved oriented strand board (OSB) panel or board with higher resin loading and control of the density to provide improved and/or enhanced properties, and methods of manufacturing such an improved OSB panel or board. In several exemplary embodiments, as described in greater detail below, resin loading of the strands used for OSB formation is increased in conjunction with the density of the manufactured OSB board being controlled to a certain density or within certain density ranges for use with decorative panels, exterior cladding or siding panels, engineered wood flooring, and/or exterior structural wall or roofing panels. Both increased resin-loading and controlled density increases are required for overall core performance increases, and the surprisingly enhanced performance characteristics outweigh the increased cost of production.

### BRIEF DESCRIPTION OF THE DRAWINGS

FIG. 1 shows a cross section view of an improved OSB panel product in accordance with an exemplary embodiment of the present invention.

FIG. 2 shows a cross section view of a three-layer improved OSB panel product.

FIG. 3 shows a cross section view of a three-layer improved OSB panel product with layers of varying thickness.

FIG. 4 shows an exemplary method for producing an improved OSB panel product.

FIG. 5 shows a visual comparison of the edges of two OSB panel products with different densities and resin loading.

FIGS. 6 and 7 show visual comparisons of the surfaces of two OSB panel products with different densities and resin loading.

### DETAILED DESCRIPTION OF EXEMPLARY EMBODIMENTS

In various exemplary embodiments, the present invention comprises an improved oriented strand board (OSB) panel or board with higher resin loading and control of the density to provide improved and/or enhanced properties, and methods of manufacturing such an improved OSB panel or board. In several exemplary embodiments, as described in greater detail below, resin loading of the strands used for OSB formation is increased in conjunction with the density of the manufactured OSB board being controlled to a certain density or within certain density ranges for use with decorative panels, exterior cladding or siding panels, engineered wood flooring, and/or exterior structural wall or roofing panels. Both increased resin-loading and controlled density increases are required for overall core performance increases, and the surprisingly enhanced performance characteristics outweigh the increased cost of production.

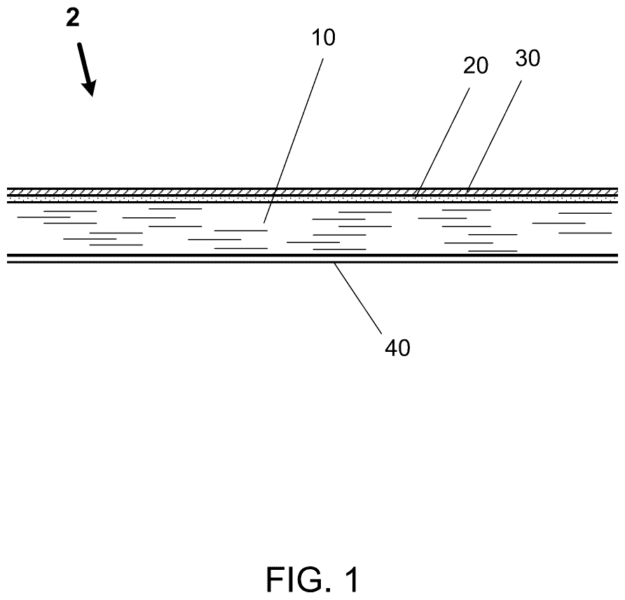

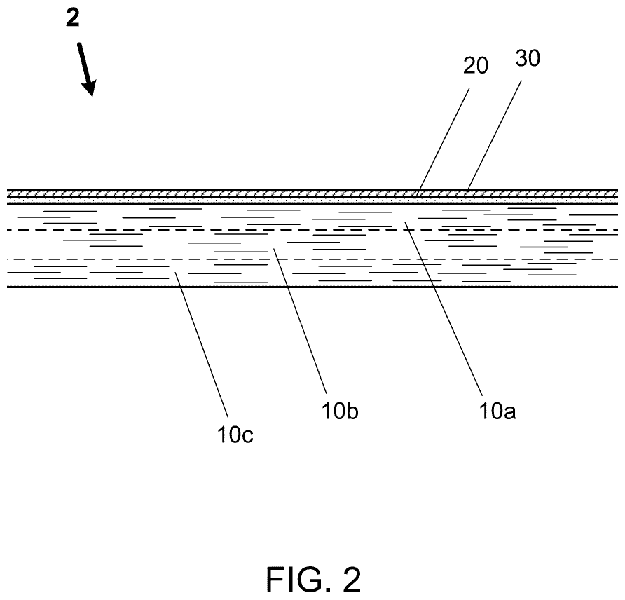

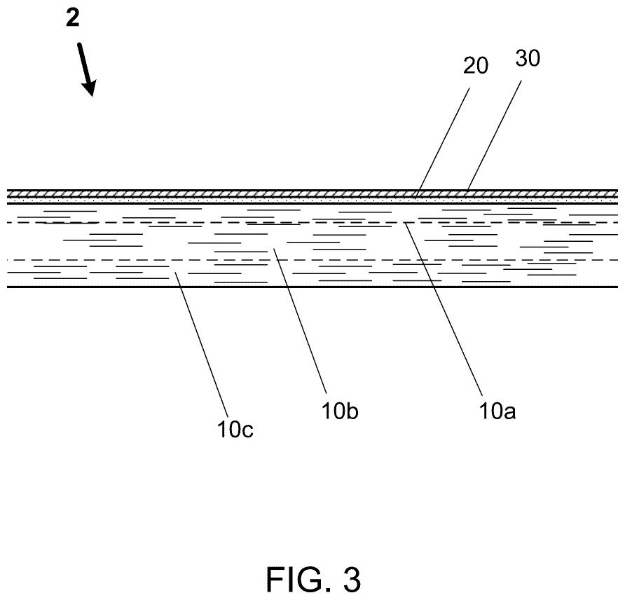

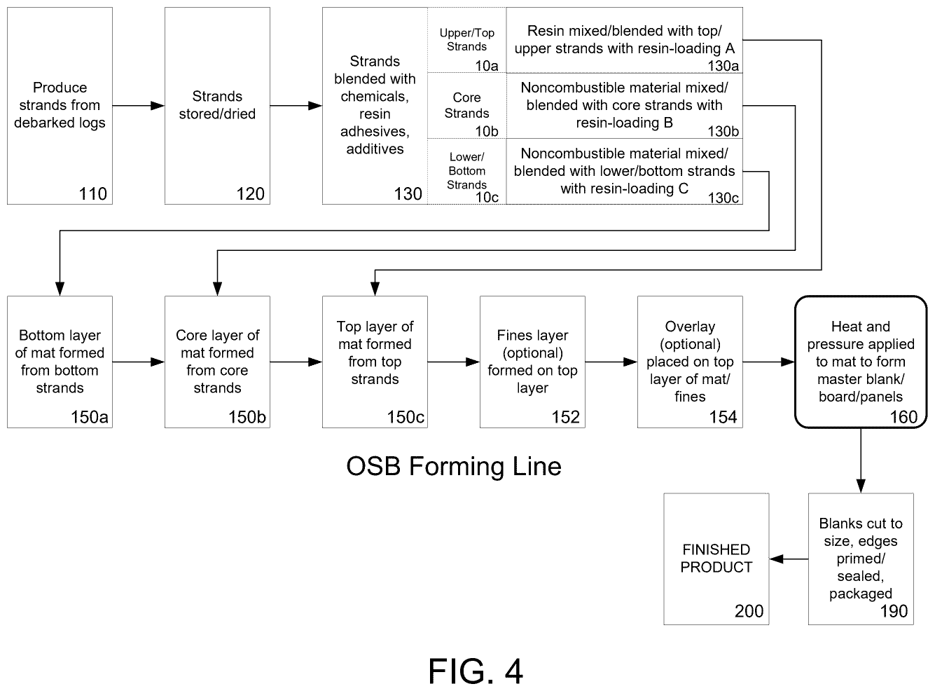

The number of strand layers in the OSB panel or board may vary, depending on the end use application. FIG. 1 shows an example of a panel 2 with a single strand layer 10 (i.e., no differentiation between or core or surface layers). A fines layer 20 and/or a performance overlay 30, such as a resin-impregnated paper overlay, or water or weather resistant barrier (WRB), may also be applied as known in the prior art. In some cases, an underlay 40 may also be applied to the underside. FIG. 2 shows an example of a panel 2 with a three strand layers: a top (upper) surface layer 10a, a bottom (base, lower) surface layer 10b, and a core (middle, interior) layer 10c. The layers may be equal or unequal in thickness, as seen in FIGS. 2 and 3. The process also may include control of strand orientation of strands within some or all layers. Strand size is in the normal ranges of length, width, and thickness for OSB, and the standard OSB manufacturing methods, as modified herein, as seen in FIG. 4, may be used.

### Strand Species:

Strand species for use with OSB in accordance with the present invention comprise a variety of hardwoods and softwoods that can be used for manufacturing. In one embodiment, aspen is the strand species. In an alternative embodiment, southern yellow pine is the strand species. Alternative wood species, such as, but not limited to, basswood, poplar, eucalyptus, birch, soft maple, and/or pine, may be blended in various combinations with aspen or southern yellow pine or other primary wood species.

### Resin-Loading:

The resin blended with the strands may be amino resin, such as, but not limited to melamine formaldehyde, melamine urea formaldehyde, phenol formaldehyde (PF), a blend of amino resin and MDI resin, or 100% MDI resin. In one exemplary embodiment, the preferred resin is 100% MDI resin. The resins used in surface layers and core layers may be the same or different, and the levels and loading of resins in surface layers and core layers also may be the same or different.

Resin loading is weight of resin/weight of strands expressed as a percentage. Thus, where there is 10 pounds of resin per 100 lbs of strands, the resin loading is 10%.

In various embodiments of the present invention, the resin-loading ranges from greater than 4% to approximately 20%, more particularly from greater than 6% to approximately 14%, preferably from approximately 8% to approximately 14%, more preferably from approximately 8% to approximately 10%. In specific examples, the amount of resin loading is approximately 8.0%, approximately 8.5%, approximately 9.0%, approximately 9.5%, or approximately 10.0%.

These ranges may be applicable to all strand layers, or in some embodiments, the resin-loading ranges may vary between a core (or inner) layer, and one or both surface (or outer) layers. Thus for example, an OSB panel may have a single layer with approximately 10% resin-loading, or at least 10% resin-loading, with a single type of resin such as MDI. In contrast, another OSB panel may have multiple layers (e.g., three layers), with the core strand layer having approximately 6% resin-loading, or at least 6% resin-loading, and one or both surface strand layers having approximately 10% resin-loading, or at least 10% resin-loading, with the type of resin used being the same for all layers (e.g., MDI resin in all layers), or being different (e.g., 6% MDI resin in the core layer, 10% PF resin in the surface or face layers).

Along with resin, certain additives, including, but not limited to, waxes, insecticides, preservatives, flame retardants, UV stabilizers, reinforcing fillers, and humectants, may be added, blended, or mixed with the strands prior to formation of the mat(s) on the forming line.

Further, a fines layer may or may not be added to the top of the mat(s) on the forming line, but prior to pressing. In general, a fines layer is not used for flooring OSB panels and boards, which comprise only strand layers. A fines layer is more likely to be used for decorative panels, exterior cladding or siding panels, and/or exterior structural wall or roofing panels.

### Moisture Content:

The moisture content of strands may be in the range of approximately 2% to approximately 12%, more preferably approximately 4% to approximately 8%, most preferably approximately 4% to approximately 6%. The moisture content (% MC) is determined as water weight/wood weight in percentage form. Thus, 100 pounds of oven-dried wood has 0% MC, and the same wood with 6 pounds of water/moisture (so the total weight of wood with moisture is 106 pounds) has 6% MC.

### Density:

The strand mat(s) on the forming line are then subject to heat and pressure in a press, such as a multi-layer press. Density is controlled by several factors, including, but not limited to, the amount of strand material added to the mat, the amount of pressure applied, the time in the press, and the temperature of the press. In various embodiments of the present invention, the density of the panel after pressing ranges from approximately 30 pcf (pounds per cubic foot) to approximately 52 pcf, preferably approximately 34 to approximately 50 pcf, more preferably approximately 42 to approximately 46 pcf for some applications, or more preferably approximately 34 to approximately 38 pcf for other applications, or more preferably approximately 50 pcf to 52 pcf for certain applications requiring high density panels.

For OSB panels used for flooring and/or structural panels (e.g., wall or roofing panel) applications, the density of the panel after pressing ranges from approximately 40 pcf to approximately 52 pcf, preferably approximately 42 to approximately 46 pcf, and more preferably approximately 44 to approximately 46 pcf. In one embodiment, the density of the panel after pressing is 46 pcf, or alternatively 47 pcf, alternatively 48 pcf, alternatively 49 pcf, alternatively 50 pcf, alternatively 51 pcf, alternatively 52 pcf, or alternatively at least 52 pcf.

For OSB panels used for decorative applications and the like, the density of the panel after pressing may ranges from approximately 30 pcf to approximately 42 pcf, preferably approximately 34 to approximately 42 pcf, and more preferably approximately 34 to approximately 38 pcf.

### Coatings:

The surface(s) and/or edge(s) of the OSB panel produced as described herein may be uncoated, or alternatively, coated with a variety of paints, primers, and/or coatings of various types and formulations, including, but not limited to, epoxy, acrylate, polyurethane, PUR-acrylate blends, oils, elastomers, thermoplastics, thermosets, waxes, polyols, varnish, shellac, lacquer, nitrocellulose, aliphatic, stain, dye, hydrophobic coating, nano coating, superhydrophobic coating, water based coatings, and/or solvent based or 100% solids coatings. These paints, primers and/or coatings may be air dried, oven dried, forced air, UV-curable, e-beam curable, self-crosslinking, or self-drying. In one exemplary embodiments, a super hydrophobic coating is applied to all edges and surfaces.

### Advantages:

The OSB panels with increased density and resin-loading, produced as described herein, exhibit enhanced properties over prior-art OSB panels, including the following:
1. Increased dimensional stability with reduced bulk water uptake and a reduced tendency for warping under changing environmental conditions, as demonstrated by a 24-hour submersion swell-test, evaluation thickness swell test, Cobb ring test, and/or kitchen cabinet edge swell test.
2. Improved screw or other fastener retention.
3. Better machinability, with better profiling (e.g., surface smoothness of tongue-and-groove or other joint profiles cut into panel edges), reduced or elimination of stray fibers, and better cohesive structure.
4. Increased hardness.
   These advantages are discussed below in greater detail.

### Methods:

An example of the method of the present invention is shown in FIG. 4, strands are produced from debarked logs 110 and dried and stored 120. The strands are then blended with resins, adhesives, and other chemicals, with resin-loading in the percentage ranges described above 130, 130a, 130b, 130c. FIG. 4 shows that the strands intended to form particular layers may be treated differently, in whole or in part, with different resin-loading (different resin percentages and/or different resin types) 130a-c. For example, the upper and lower surface strands may be blended with a resin at a first resin-loading percentage (i.e., 130a and 130c are the same), while the core layer may be blended with a resin at a second resin-loading percent (i.e., 130b, which is different from 130a and 130c). In alternative embodiments, all three strand layers may be treated with (1) the same resin type and the same resin-loading percentage, (2) different resin types (at least one layer is different), but the same resin-loading percentage, (3) the same resin type but different resin-loading percentages (at least one layer is different), and/or (4) different resin types (at least one layer is different) and different resin-loading percentages (at least one layer is different).

The treated strands are then used to form multiple respective layers of a strand mat (e.g., bottom layer 150c, core layer 150b, top layer 150a) on a forming line. Strands used to form multiple layers may be treated together, or may be treated separately as shown 130a, 130b, 130c, so that strands in different layers may comprise different types and/or amounts of resin, as described above.

An optional fines layer 152 may be added to the upper surface of the strand mat, as is known in the prior art. An optional overlay or layer 154 also may be added on top of the mat, with or without any fines layer.

After the mat is formed (which may include an optional fines layer on the mat upper surface), and any pre-press overlay (e.g., paper overlay, resin-impregnated paper overlay, or the like) is applied to the mat, the mat and any overlay are subjected to heat and pressure in a press 160 to form panels or “blanks”. The density of the panels is controlled by the amount of strand material added to the mat, the amount of pressure applied, the time in the press, and the temperature of the press, as described above. In general, more strand material and higher pressures (and/or temperature and time, in several embodiments) result in higher density. After removal from the press, the master blanks/board/panels are then trimmed or cut to the desired size(s) (e.g., a master can be trimmed, cut or divided in multiple panels or boards of typical sizes sold in the marketplace, such as 4′×8′ panels), with surfaces and/or edges primed and/or sealed, and packaged 190 to produce the finished product 200. In some embodiments, the blanks, boards or panels, before or after being cut to size, may be subject to lamination or secondary pressing with other overlays, panels, or boards, such as MDF or HDF panels or boards.

### EXAMPLES

Examples of panels produced according to the above methods and variations thereof are discussed below.

Example 1: Southern Yellow Pine (SYP) Strands with the Same Resin-Loading were Used to produce OSB panels according to the present invention with densities of 43, 46, 48, 50 and 52 pcf. Table 1 below shows the increase in average Janka hardness values. The Janke hardness test measures the resistance of a sample of wood to denting and wear by measuring the force required to embed a 11.28 mm diameter ( 7/16 in. diameter) steel ball halfway into the sample. The diameter of the ball was chosen to produce a circle with an area of 100 square mm, or one square centimeter. When testing wood in lumber or board form, a commonly used testing procedure is that prescribed in the ASTM D1037 (“Standard Test Methods for Evaluating Properties of Wood-Base Fiber and Particle Panel Materials,” lasted revised in 2020). The Janka hardness number is usually given in pounds-force (lbf).

Twenty tests were made for each batch of samples. The % increase in Janka hardness on Table 1 is based on the 43 pcf sample. The test data shows an increase in average Janka hardness values with an increase in panel density at the same level of resin-loading, with particularly surprising jumps with the 46 pcf and the 50 pcf SYP samples.

TABLE 1

| | | RESIN- | JANKA | |
|---|---|---|---|---|
| SAMPLE | DENSITY | LOADING | HARDNESS | % |
| # | (pcf) | (MDI) (%) | (mean) (lbf) | INCREASE |
| 1 | 43 | 6 | 955.73 | 0% |
| 2 | 46 | 6 | 1239.535 | 29.70% |
| 3 | 48 | 6 | 1356.365 | 41.92% |
| 4 | 50 | 6 | 1396.915 | 46.16% |
| 5 | 52 | 6 | 1571.85 | 64.47% |

Example 2: Aspen strands with the same resin-loading (6% MDI) were used to produce OSB panels according to the present invention with densities of 34, 38, and 42 pcf. Table 2 below shows the increase in average Janka hardness values. Twenty-one tests were made for each batch of samples. The % increase in Janka hardness on Table 2 is based on the 34 pcf sample. The test data shows an increase in average Janka hardness values with an increase in panel density at the same level of resin-loading, with a particularly surprising jump for the 42 pcf Aspen samples.

TABLE 2

| | | RESIN- | JANKA | |
|---|---|---|---|---|
| SAMPLE | DENSITY | LOADING | HARDNESS | % |
| # | (pcf) | (MDI) (%) | (mean) (lbf) | INCREASE |
| 6 | 34 | 6 | 799.1024 | 0% |
| 7 | 38 | 6 | 968.00411 | 21.14% |
| 8 | 42 | 6 | 1240.097 | 55.18% |

Example 3: Aspen strands with the same resin-loading (8% MDI) were used to produce OSB panels according to the present invention with densities of 34, 38, and 42 pcf (same densities as Example 2). Table 3 below shows the increase in average Janka hardness values. Twenty-one tests were made for each batch of samples. The % increase in Janka hardness on Table 2 is based on the 34 pcf sample. The test data shows an increase in average Janka hardness values with an increase in panel density at the same level of resin-loading, with a particularly surprising jump for the 42 pcf Aspen samples.

TABLE 3

| | | RESIN- | JANKA | |
|---|---|---|---|---|
| SAMPLE | DENSITY | LOADING | HARDNESS | % |
| # | (pcf) | (MDI) (%) | (mean) (lbf) | INCREASE |
| 9 | 34 | 8 | 956.67902 | 0% |
| 10 | 38 | 8 | 1023.3829 | 6.97% |
| 11 | 42 | 8 | 1216.1943 | 27.13% |

Example 4: Aspen strands with the same resin-loading (10% MDI) were used to produce OSB panels according to the present invention with densities of 34, 38, and 42 pcf (same densities as Examples 2 and 3). Table 4 below shows the increase in average Janka hardness values. Twenty-one tests were made for each batch of samples. The % increase in Janka hardness on Table 4 is based on the 34 pcf sample. The test data shows an increase in average Janka hardness values with an increase in panel density at the same level of resin-loading, with particularly surprising jumps for the 38 and 42 pcf Aspen samples.

TABLE 4

| | | RESIN- | JANKA | |
|---|---|---|---|---|
| SAMPLE | DENSITY | LOADING | HARDNESS | % |
| # | (pcf) | (MDI) (%) | (mean) (lbf) | INCREASE |
| 12 | 34 | 10 | 869.82459 | 0% |
| 13 | 38 | 10 | 1092.8232 | 25.64% |
| 14 | 42 | 10 | 1158.5463 | 33.19% |

A comparison of the data in Tables 2-4 also shows that an increase in resin loading at the same panel density results in no statistical or substantial change in the average Janka hardness values for SYP (resin loading at 6%, 8% and 10% for 34 pcf and 42 pcf) or for Aspen (resin loading at 6%, 8% and 10% for 38 pcf and 42 pcf).

Example 5: Southern Yellow Pine (SYP) strands with varying resin-loading using 100% MDI resin (6%, 8%, 10%) were used to produce OSB panels according to the present invention with a density of 42 pcf. Table 5 below shows the decrease in average swelling of the produced panels with increased resin-loading. This demonstrates “dimensional stability” of the OSB panels, as determined by the degree with which the wood shrinks and swells with changing moisture content. The test used for these samples is a 24-hour water soak test, and is measured by the percentage change in the wood from a standard, pre-soak condition to its comparative dimension after soaking.

Fourteen tests were made for each batch of samples. The % decrease in relative average swell on Table 2 is based on the 6% MDI sample. The test data shows a decrease in average swell percentages with an increase in resin-loading at the same level of density, with particularly surprising jumps in swell reduction from the 8% to 10% samples.

TABLE 5

| | | RESIN- | | |
|---|---|---|---|---|
| SAMPLE | DENSITY | LOADING | AVERAGE | % |
| # | (pcf) | (MDI) (%) | SWELL (%) | DECREASE |
| 15 | 42 | 6 | 14.16 | 0% |
| 16 | 42 | 8 | 12.911 | 8.82% |
| 17 | 42 | 10 | 11.018 | 22.19% |

Example 6: Southern Yellow Pine (SYP) strands with constant resin-loading (MDI 10%) were used to produce OSB panels according to the present invention with densities of 34, 38 and 43 pcf. Table 6 below shows the average swell percentage of the produced panels with increased density, using the same test method described above. Fourteen tests were made for each batch of samples. Surprisingly, the test data shows little impact on average swell percentages with increases in density at a constant 10% resin-loading, indicating that density alone likely will not provide a substantial impact on water resistance.

TABLE 6

| SAMPLE | DENSITY | RESIN-LOADING | AVERAGE SWELL |
|---|---|---|---|
| # | (pcf) | (MDI) (%) | (%) |
| 18 | 34 | 10 | 10.782085 |
| 19 | 38 | 10 | 11.220789 |
| 20 | 42 | 10 | 11.01776 |

Example 7: Aspen strands with constant resin-loading (10%) were used to produce OSB panels according to the present invention with a density of 46 pcf but with different strand/flake thickness (thin and thick). Table 3 below shows the average swell percentage of the produced panels with thin flakes and thick flakes, using the same test method described above. Six tests were made for each batch of samples. The test data shows little impact on average swell percentages with only changes in flake size.

TABLE 7

| | STRAND/ | | RESIN- | AVERAGE |
|---|---|---|---|---|
| SAMPLE | FLAKE | DENSITY | LOADING | SWELL |
| # | SIZE | (pcf) | (MDI) (%) | (%) |
| 21 | thick | 46 | 10 | 14.680188 |
| 22 | thin | 45 | 10 | 14.143165 |

Example 8: Aspen strands with variable resin-loading (MDI 8% and 10%) were used to produce OSB panels according to the present invention with constant density of 42 pcf. Table 8 below shows the average swell percentage of the produced panels with increased resin-loading, using the same test method described above. Fourteen tests were made for each batch of samples. Surprisingly, the test data shows substantial impact on average swell percentages with an increase in resin-loading from 8% to 10% MDI.

TABLE 8

| | | RESIN- | AVERAGE | |
|---|---|---|---|---|
| SAMPLE | DENSITY | LOADING | SWELL | % |
| # | (pcf) | (MDI) (%) | (%) | DECREASE |
| 23 | 42 | 8 | 13.6792 | 0% |
| 24 | 42 | 10 | 10.6882 | 21.86% |

Additional testing with constant resin-loading at different densities (SYP: 6% MDI at 42, 34, and 38 pcf; Aspen: 8% MDI at 44 and 46 pcf) showed no or minimal impact on average swell percentage.

### Machinability and Panel Properties

Machinability refers to the ease with which a material (e.g., wood) can be machined or shaped using processes like cutting, drilling, milling, and turning. It includes factors such as cutting speed, cut smoothness, surface finish, edge and joint cutting, dimensional accuracy, and overall efficiency.

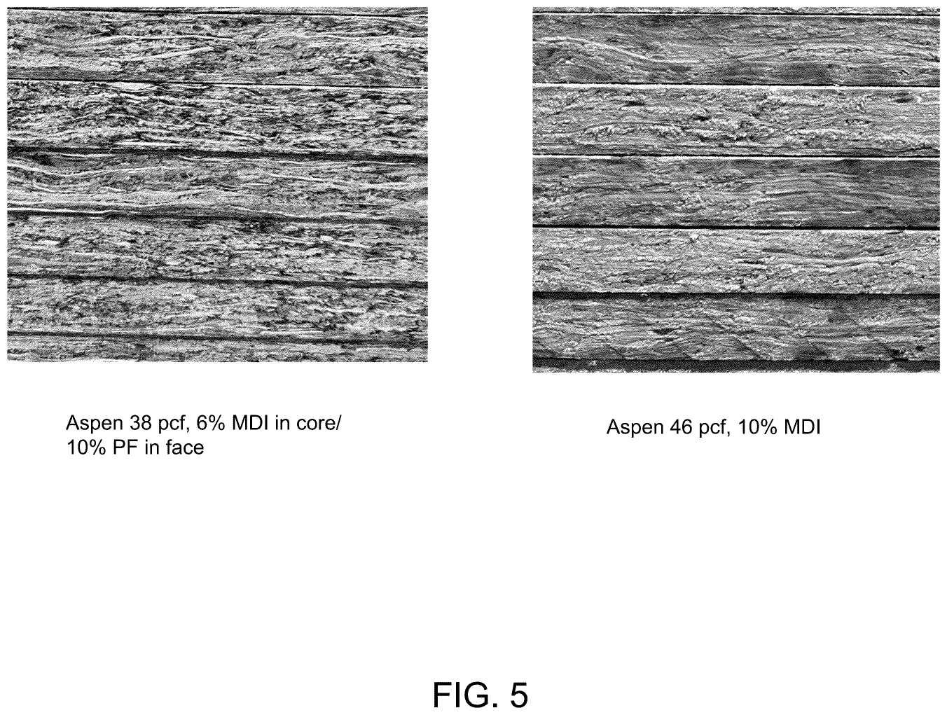

For gauging machinability of sample panels produced according to the present invention, visual evaluation of the number and size of voids (spaces or gaps in the engineered wood) for both the edges and the surfaces of several panels was made. FIG. 5 shows a comparison of the edges of two samples, both produced with Aspen strands. The left picture shows an Aspen panel at 38 pcf, with 6% MDI resin in the core layer and 10% PF resin in the surface layers, while the right show an Aspen panel at 46 pcf with 10% MDI resin in all layers. The increase in panel density and resin-loading resulted in the decrease of visible voids on the edges of the samples, which reflect the decrease of voids in the interior of the panels.

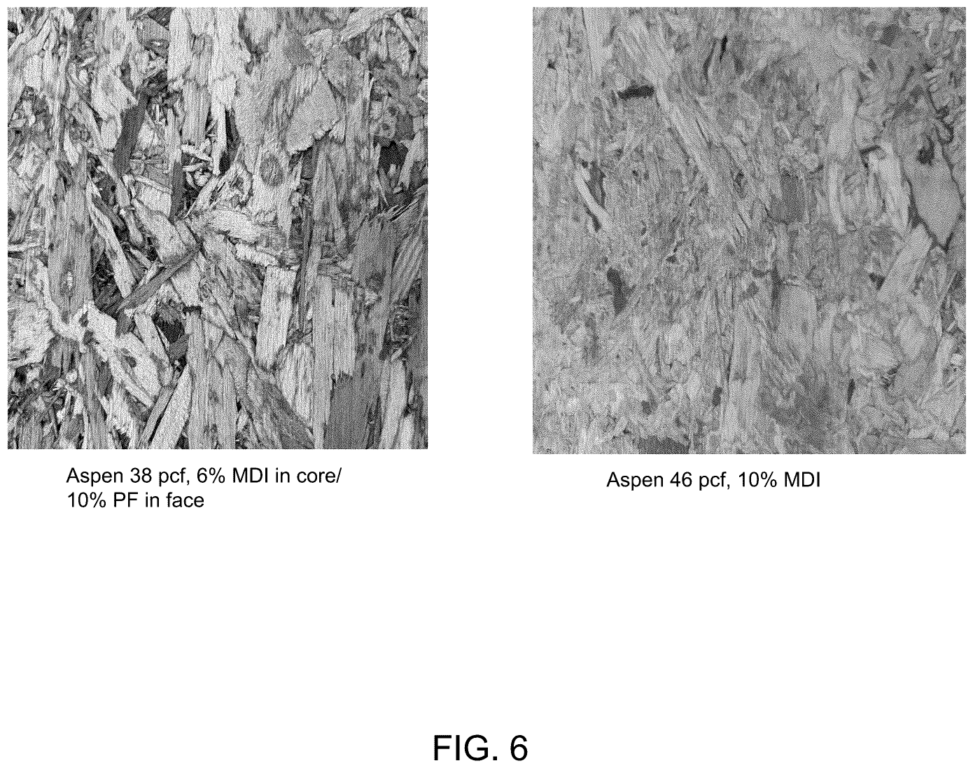

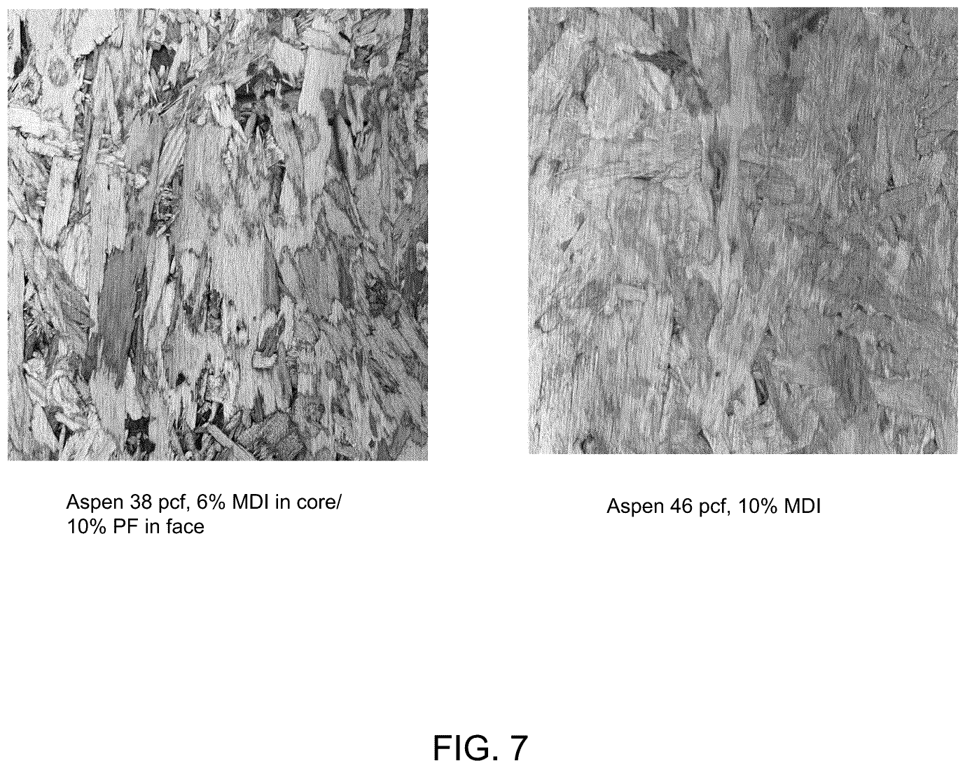

FIGS. 6 and 7 shows a comparison of surface view of the same samples, Aspen at 38 PCF, 6% MDI core and 10% PF surface on the left, Aspen at 46 PCF, 10% MDI throughout on the right. These surface views confirm that the increase in panel density and resin-loading results in the decrease of voids in the manufactured wood product. In general, panels with densities of 34-38 pcf exhibited rougher surfaces with more voids and imperfections as compared to panels with 42-46 pcf densities.

The effect of resin-loading also has an effect. In one profiling study, three sets of OSB panels were manufactured at 46 pcf density with varying levels of MDI resin loading (6%, 10%, 14%). These panels were cut into planks and were profiled on the long sides and short sides with a tongue and groove to determine the impact of resin loading on machinability. Although all planks were successfully profiled, tongue and groove engagement was much easier and smoother for planks with higher resin loading. These planks exhibited cleanly profiled surfaces with no fiber tear. More fine fibers were seen sticking up (i.e., fiber tear) from the profiled surfaces on the 6% resin-loaded planks, which resulted in more difficulty engaging the tongue and groove profiles at the standard tolerances required. Once engaged, it was very difficult to move (slide) the planks along the interlocked profiles, which is a required attribute of wood flooring installers.

Accordingly, methods or processes to produce the improved engineered wood panel of the present invention comprise the steps of: blending a first plurality of wood strands with a first resin mixture to form a first strand mixture; forming, on a forming line, a strand mat comprising a first layer formed from said first strand mixture, wherein said first layer comprises a first resin load of at least 6%, based on weight of resin/weight of strands; and applying, in a press, heat and pressure to the strand mat to form an engineered wood blank or panel; wherein said engineered wood blank or panel has a density after pressing from approximately 40 pcf to approximately 52 pcf. The method further comprises the steps of: blending a second plurality of wood strands with a second resin mixture to form a second strand mixture; forming, on the forming line prior to the step of applying heat and pressure, and on top of the first layer, a second layer of the strand from said second strand mixture, wherein said second layer comprises a second resin load of at least 6%, based on weight of resin/weight of strands; blending a third plurality of wood strands with a third resin mixture to form a third strand mixture; and forming, on the forming line prior to the step of applying heat and pressure, and on top of the second layer, a third layer of the strand mat from said third strand mixture, wherein said third layer comprises a third resin load of at least 6%, based on weight of resin/weight of strands. The first resin mixture may comprise MDI resin or a phenol formaldehyde resin, or another suitable resin type. The first, second, and third resin mixtures may be the same type of resin, or one or more may be different, e.g., at least one of the second resin mixture and the third resin mixture comprises MDI resin or a phenol formaldehyde resin. In some embodiments, at least one of the first resin load, the second resin load, and third resin load has a different resin type than the others.

In several embodiments, the first layer is a bottom surface layer, the second layer is a core layer, and the third layer is a top surface layer. The strands in at least two of said layers may be in specific orientations, and the strands in at least two of said layers may be cross-oriented with respective to each other, thereby forming oriented strand board (OSB). The first resin load, the second resin load, and third resin load may all be the same resin load percentage, or, in the alternative, at least one of the first resin load, the second resin load, and third resin load has a different resin load percentage than the others. In specific exemplary embodiments, (A) the first resin load is at least 6%, the second resin load is at least 6%, and the third resin load is at least approximately 10%; (B) the first resin load is at least 10%, the second resin load is at least 6%, and the third resin load is at least approximately 10%; (C) the first resin load is at least 10%, the second resin load is at least 8%, and the third resin load is at least approximately 10%.

The density of the engineered wood blank or panel after pressing is determined by two or more of the following factors: the amount of strand material in the strand mat prior to pressing; the amount of pressure applied by the press; the temperature of the press; and the time the strand mat is subjected to pressure and/or heat in the press. In some embodiments, the density of the engineered wood blank or panel after pressing is determined by three or more of the following factors: the amount of strand material in the strand mat prior to pressing; the amount of pressure applied by the press; the temperature of the press; and the time the strand mat is subjected to pressure and/or heat in the press. In some embodiments, all four of these factors may be used to control/determine the density. In specific exemplary embodiments, (A) the engineered wood blank or panel has a density after pressing from approximately 50 pcf to approximately 52 pcf; (B) the engineered wood blank or panel has a density after pressing of at least 46 pcf; (C) the engineered wood blank or panel has a density after pressing of at least 48 pcf; (D) the engineered wood blank or panel has a density after pressing of at least 50 pcf. The density may be controlled for specific intended end-uses, as panels with lower or higher densities, or in a particular range, may be optimal for particular end-uses.

In sum, superior panel properties have been seen in panels with higher density and higher resin-loading as described herein. Increasing panel density decreases interior and surface voids in and on the OSB panels, and the increasing resin loading particularly improves machinability, allowing for smoother tongue and groove (and other joint) profiles with interlocking surfaces.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A method of manufacturing an engineered wood panel, comprising the steps of:
blending a first plurality of wood strands with a first resin mixture to form a first strand mixture;
forming, on a forming line, a strand mat comprising a first layer formed from said first strand mixture, wherein said first layer comprises a first resin load of at least 6%, based on weight of resin/weight of strands; and
applying, in a press, heat and pressure to the strand mat to form an engineered wood blank or panel;
wherein said engineered wood blank or panel has a density after pressing from approximately 40 pcf to approximately 52 pcf.

2. The method of claim 1, further comprising the steps of:
blending a second plurality of wood strands with a second resin mixture to form a second strand mixture; and
forming, on the forming line prior to the step of applying heat and pressure, and on top of the first layer, a second layer of the strand from said second strand mixture, wherein said second layer comprises a second resin load of at least 6%, based on weight of resin/weight of strands.

3. The method of claim 2, further comprising the steps of:
blending a third plurality of wood strands with a third resin mixture to form a third strand mixture; and
forming, on the forming line prior to the step of applying heat and pressure, and on top of the second layer, a third layer of the strand mat from said third strand mixture, wherein said third layer comprises a third resin load of at least 6%, based on weight of resin/weight of strands.

4. The method of claim 1, wherein the first resin mixture comprises MDI resin or a phenol formaldehyde resin.

5. The method of claim 3, wherein at least one of the second resin mixture and the third resin mixture comprises MDI resin or a phenol formaldehyde resin.

6. The method of claim 3, wherein the first layer is a bottom surface layer, the second layer is a core layer, and the third layer is a top surface layer.

7. The method of claim 3, wherein the first resin load, the second resin load, and third resin load are all the same resin load percentage.

8. The method of claim 3, wherein at least one of the first resin load, the second resin load, and third resin load has a different resin load percentage than the others.

9. The method of claim 3, wherein said the first resin load is at least 6%, the second resin load is at least 6%, and the third resin load is at least approximately 10%.

10. The method of claim 3, wherein said the first resin load is at least 10%, the second resin load is at least 6%, and the third resin load is at least approximately 10%.

11. The method of claim 3, wherein said the first resin load is at least 10%, the second resin load is at least 8%, and the third resin load is at least approximately 10%.

12. The method of claim 3, wherein at least one of the first resin load, the second resin load, and third resin load has a different resin type than the others.

13. The method of claim 1, wherein the density of the engineered wood blank or panel after pressing is determined by two or more of the following factors: the amount of strand material in the strand mat prior to pressing; the amount of pressure applied by the press; the temperature of the press; and the time the strand mat is subjected to pressure and/or heat in the press.

14. The method of claim 1, wherein said engineered wood blank or panel has a density after pressing from approximately 50 pcf to approximately 52 pcf.

15. The method of claim 1, wherein said engineered wood blank or panel has a density after pressing of at least 46 pcf.

16. The method of claim 1, wherein said engineered wood blank or panel has a density after pressing of at least 48 pcf.

17. The method of claim 1, wherein said engineered wood blank or panel has a density after pressing of at least 50 pcf.

18. The method of claim 3, wherein the strands in at least two of said layers are in specific orientations.

19. The method of claim 3, wherein the strands in at least two of said layers are cross-oriented with respective to each other, and the manufactured engineered wood panel comprises oriented strand board.

20. A manufactured engineered wood panel according to the method of claim 3, wherein the manufactured engineered wood panel comprises a three-layer oriented strand board.
